(19) United States
(12) Patent Application Publication
(10) Pub. No.: US 2015/0155689 A1
(43) Pub. Date: Jun. 4, 2015

(54) EXTENSIBLE ELECTRICAL RING MAIN UNIT

(71) Applicants: Subbiah Thevar Dukkaiappan, Maharashtra (IN); Pravin Ashok Futane, Maharashtra (IN); Srinivasa Rao Cheerla, Andhra Pradesh (IN); Gaurav Diliprao Hatgaonkar, Maharashtra (IN)

(72) Inventors: Subbiah Thevar Dukkaiappan, Maharashtra (IN); Pravin Ashok Futane, Maharashtra (IN); Srinivasa Rao Cheerla, Andhra Pradesh (IN); Gaurav Diliprao Hatgaonkar, Maharashtra (IN)

(73) Assignee: ABB TECHNOLOGY LTD, Zürich (CH)

(21) Appl. No.: 14/375,110

(22) PCT Filed: Dec. 21, 2011
(86) PCT No.: PCT/IB2011/003098

§ 371 Date: Feb. 19, 2015

(51) Int. Cl. H02B 7/06; H02B 13/00; H02B 7/01

(52) U.S. Cl. CPC H02B 7/06; H02B 7/01; H02B 13/005

(57) ABSTRACT

The present disclosure provides an electrical ring main unit having circuit breaker unit or fuse unit or load break switch or suitable combination thereof and common bus bar assembly. The electrical ring main unit is hermetically sealed and includes at least one opening suitably located in therein. The opening is provided in the electrical ring main unit to interchangeably accommodate an insulating plug of an insulating plug assembly or an extensible cable bushing of extensible cable bushing assembly.

### FIELD OF THE INVENTION

The present invention relates to an electrical ring main unit, and more particularly to an electrical ring main unit that can be made extensible when the need arises.

### BACKGROUND OF THE INVENTION

Generally, ring main units are of extensible or non extensible type based on its capability of being extended, so as to be connected to other ring main unit. Such extension is provided through extensible cable bushings suitably located on the ring main unit.

In practice, the need for an extensible ring main unit for current use or future use has to be anticipated accordingly, at the time of manufacturing the ring main unit, so that the extensible cable bushings are provided during the manufacture of the ring main unit. In such cases, the extensible cable bushings are required to be provided, whether there is a current need for it or not. Besides this, various other considerations and anticipatory presumptions like the number of extensible cable bushings that needs to be provided i.e., on one side or on either side of the ring main unit etc., have to be made at the time of manufacturing the extensible ring main unit. In the case where extension is or will be required on only one side of the ring main unit, the corresponding side where the extensible cable bushing is required to be provided has to be decided as well.

On the other end, it is not practically possible to convert a non extensible ring main unit to an extensible ring main unit later at the site after deployment, since it involves structural and design changes that are not viable at the site. Also, in some, at times most cases, the non extensible ring main unit are not converted to extensible ring main unit due to the major setbacks in making structural changes or of limitations thereof.

Hence there is a need for an electrical ring main unit that is capable of being extended only when the actual need arises and made functionally extendable thereof.

### OBJECTS OF THE INVENTION

It is an object of the invention to provide an electrical ring main unit in which the need for providing extensible cable bushings in the absence of an actual need for the same is eliminated.

It is another object of the invention to provide an electrical ring main unit wherein the extensible cable bushings can be provided when the actual need for the same arises.

It is also an object of the invention to provide an electrical ring main unit that is flexible and non restrictive with regard to the side on which the extensible cable bushing(s) can be provided.

It is a further object of the invention to provide an electrical ring main unit that is simple in construction.

Yet another object of the invention is to provide an electrical ring main unit that correspondingly accommodates extensible cable bushings with minimal or no structural changes in the electrical ring main unit.

### SUMMARY OF THE INVENTION

Accordingly the invention provides an electrical ring main unit having circuit breaker unit or fuse unit or load break switch or suitable combination thereof and common bus bar assembly. The electrical ring main unit is hermetically sealed and comprises at least one opening suitably located in therein. The opening is provided in the electrical ring main unit to interchangeably accommodate an insulating plug of an insulating plug assembly or an extensible cable bushing of extensible cable bushing assembly.

### BRIEF DESCRIPTION OF THE DRAWINGS

With reference to the accompanying drawings in which:

FIG. 1 shows an extensible cable bushing assembly and its associated elements of an electrical ring main unit;

FIG. 2a shows an insulating plug assembly and its associated elements of an electrical ring main unit in accordance with the invention; and

FIG. 2b shows an insulating plug in respect of FIG. 2a.

### DETAILED DESCRIPTION

The invention is herein after described with reference to non exhaustive exemplary embodiment.

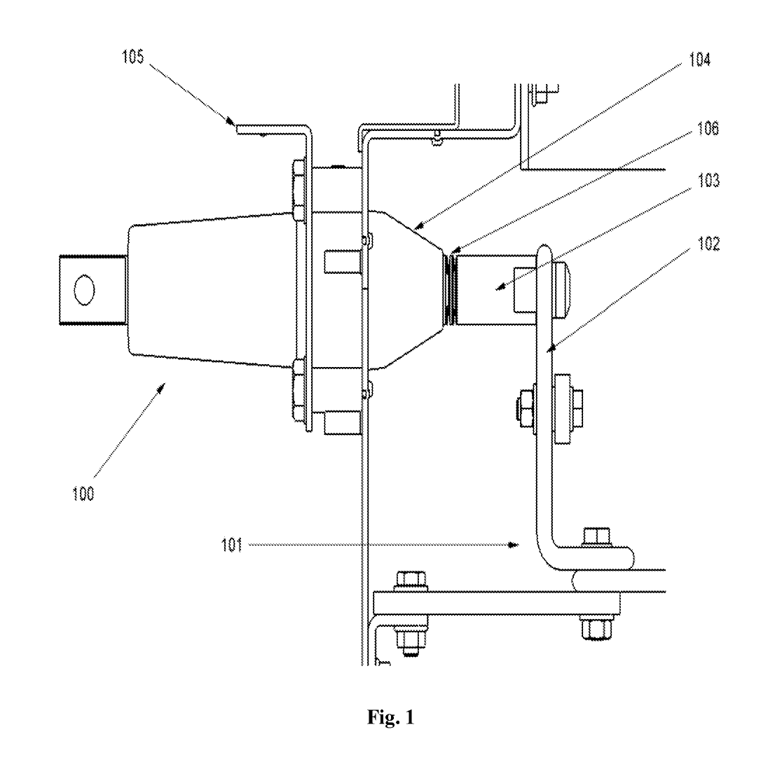

FIG. 1 shows a hermetically sealed electrical ring main unit filled with an insulating gas such as SF6. The electrical ring main unit is of extensible type, by which it can be connected to other electrical ring main unit. The electrical ring main unit has at least one extensible cable bushing assembly (100) and a common bus bar assembly (101).

The extensible cable bushing assembly (100) has an extensible cable bushing (104) provided in the respective/corresponding opening in the electrical ring main unit, so as to provide required extension to the electrical ring main unit in order to connect it to other electrical ring main unit. The said opening to accommodate the extensible cable bushing (104) and of the extensible cable bushing assembly (100) thereof is suitably provided in the electrical ring main unit, in a manner to effect appropriate alignment between the extensible cable bushing (104) and the internal coupling piece (103) of the common bus bar assembly (101). The internal coupling piece (103) is connected to the coupling L piece (102) of the common bus bar assembly (101).

The extensible cable bushing assembly (100) is positioned accordingly in the electrical ring main unit with the aid of a notch provided on the extensible cable bushing (104) together with the clamping plate (105). The clamping plate (105) along with washers (106) like Belleville washers provide necessary contact force that is required for ensuring proper contact between the extensible cable bushing (104) and the internal coupling piece (103) of the common bus bar assembly (101).

The electrical ring unit is hermetically sealed employing the known method or process. The extensible electrical ring main unit of this type as described here before is produced considering the requirement of making it extensible, either due to present requirement and/or future requirement. Such electrical ring main unit does not provide flexibility to cater to the need of being extensible that arises in future if required extensible cable bushings are not provided during production. Besides this, it can also be inferred that providing such provision for making the electrical ring main unit extensible becomes demanding even in the absence of present and/or actual need.

Considering the above, an electrical ring main unit that can easily cater to the need of being extensible accordingly, as and when such need arises, is required to eliminate rigidity in providing such provision for extension, and to promote or improve flexibility in providing such provision for extension.

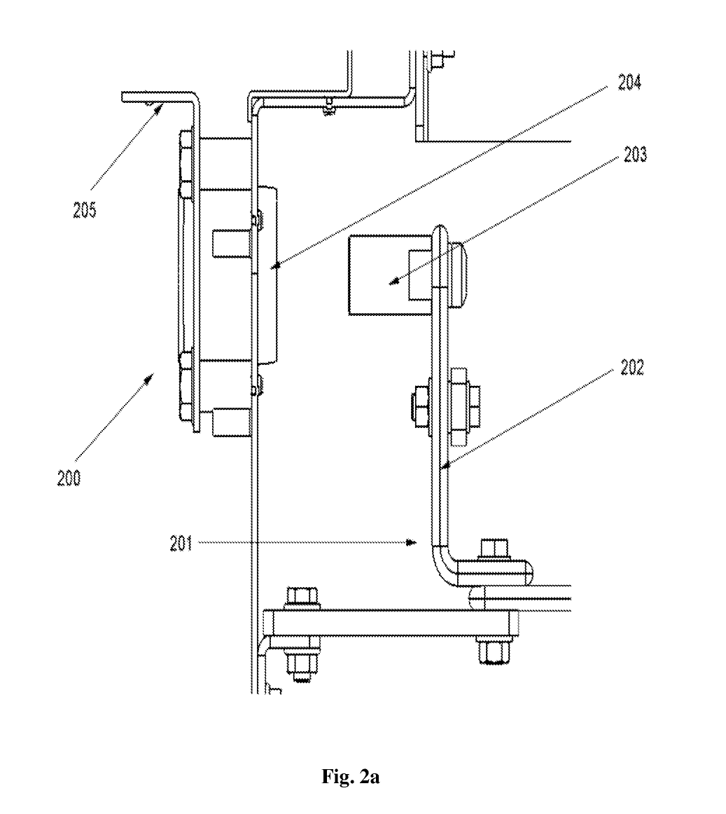

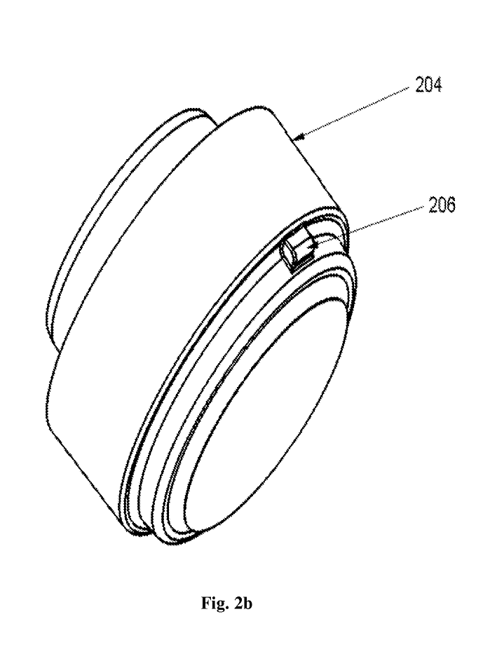

Accordingly, an electrical ring main unit in accordance with the invention as illustrated in FIGS. 2a and 2b is described further as a way of exemplary embodiment for better understanding. The electrical ring main unit has an insulating plug assembly (200) and a common bus bar assembly (201). The common bus bar assembly (201) has a coupling L piece (202) and an internal coupling piece (203) connected thereto and in alignment with each other.

The opening in the electrical ring main unit that was employed to accommodate extensible cable bushing is now employed to accommodate an insulating plug (204) of the insulating plug assembly (200). The positioning of the insulating plug (204) is ensured by the notch (206) provided on the insulating plug (204) and by the clamping plate (205). The electrical ring main unit is hermetically sealed to contain insulating gas.

It can be understood that providing insulating plug in the electrical ring main unit eliminate the need for providing the extensible cable bushing when the need for making the electrical ring main unit extensible is not present, but certainly allow providing extensible cable bushing when the need for making the electrical ring main unit extensible arises. The electrical ring main unit of the invention thereby provides more flexibility to accommodate extensible cable bushing as and when the need for the same arises. Thus, the electrical ring main unit of the invention can interchangeably accommodate insulating plug and/or the extensible cable bushing.

Only certain features of the invention have been specifically illustrated and described herein, and many modifications and changes will occur to those skilled in the art. The invention is not restricted by the preferred embodiment described herein in the description. It is to be noted that the invention is explained by way of exemplary embodiment and is neither exhaustive nor limiting. Certain aspects of the invention that not been elaborated herein in the description are well understood by one skilled in the art. Also, the terms relating to singular form used herein in the description also include its plurality and vice versa, wherever applicable. Any relevant modification or variation, which is not described specifically in the specification are in fact to be construed of being well within the scope of the invention. The appended claims are intended to cover all such modifications and changes which fall within the spirit of the invention.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. An electrical ring main unit comprising:
a circuit breaker unit, or fuse unit, or load break switch or suitable combination thereof; and
a common bus bar assembly, wherein the electrical ring main unit is hermetically sealed and includes:
at least one opening suitably located in the said electrical ring main unit to interchangeably accommodate an insulating plug of an insulating plug assembly or an extensible cable bushing of an extensible cable bushing assembly.

2. The electrical ring main unit as claimed in claim 1, wherein the opening is in corresponding alignment with the common bus bar assembly.

3. The electrical ring main unit as claimed in claim 2, wherein the alignment is in relation to an internal coupling piece of the common bus bar assembly.

4. The electrical ring main unit as claimed in claim 1, in combination with an insulating plug and insulating plug assembly to hermetically seal the electrical ring main unit, and to eliminate providing an extensible cable bushing thereof when need for providing the extensible cable bushing in the electrical ring main unit is lacking.

5. The electrical ring main unit as claimed in claim 4, wherein the insulating plug and insulating plug assembly are configured to be replaceable with an extensible cable bushing, when a need for providing the extensible cable bushing in the electrical ring main unit exists.

6. The electrical ring main unit as claimed in claim 3, in combination with an insulating plug or extensible cable bushing which comprises:
means for positioning and/or aligning the insulating plug or the extensible cable bushing in relation to the internal coupling piece or the said common bus bar assembly.

7. The electrical ring main unit as claimed in claim 6, wherein the means for positioning and/or aligning the insulating plug or the extensible cable bushing is a notch.

8. The electrical ring main unit as claimed in claim 5, wherein the insulating plug is configured to be replaced with an extensible cable bushing, in which suitable washers are provided between the extensible cable bushing and an internal coupling piece of the common bus bar assembly, for providing contact force.

9. The electrical ring main unit as claimed in claim 1, comprising:
a clamping plate for suitably sealing and positioning the electrical ring main unit in relation to an insulating plug or an extensible cable bushing.

10. The electrical ring main unit as claimed in claim 9, wherein the clamping plate is configured for exerting contact force in relation to an extensible cable bushing.

11. The electrical ring main unit as claimed in claim 1, wherein the electrical ring main unit is configured as a gas filled electrical ring main unit.

12. The electrical ring main unit as claimed in claim 11, comprising:
an insulating gas.

13. The electrical ring main unit as claimed in claim 1, wherein the electrical ring main unit is an indoor or outdoor electrical ring main unit.

14. The electrical ring main unit as claimed in claim 3, in combination with an insulating plug and insulating plug assembly to hermetically seal the electrical ring main unit, and to eliminate providing an extensible cable bushing thereof when need for providing the extensible cable bushing in the electrical ring main unit is lacking.

15. The electrical ring main unit as claimed in claim 14, wherein the means for positioning and/or aligning the insulating plug.

16. The electrical ring main unit as claimed in claim 6, comprising:
a clamping plate for suitably sealing and positioning the electrical ring main unit in relation to an insulating plug or an extensible cable bushing.

17. The electrical ring main unit as claimed in claim 6, wherein the electrical ring main unit is configured as a gas filled electrical ring main unit.

18. The electrical ring main unit as claimed in claim 12, comprising:
an insulating SF6 gas.

19. The electrical ring main unit as claimed in claim 6, wherein the electrical ring main unit is an indoor or outdoor electrical ring main unit.

20. The electrical ring main unit as claimed in claim 15, wherein the electrical ring main unit is an indoor or outdoor electrical ring main unit.
